(19) United States
(12) Patent Application Publication
(10) Pub. No.: US 2008/0072931 A1
(43) Pub. Date: Mar. 27, 2008

(54) SUBSTRATE PROCESSING APPARATUS AND METHOD

(76) Inventor: Masahiro Kimura, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/857,659

(22) Filed: Sep. 19, 2007

(30) Foreign Application Priority Data
Sep. 26, 2006 (JP) JP2006-260195
Jul. 31, 2007 (JP) JP2007-199027

(51) Int. Cl. B08B 3/00

(52) U.S. Cl. 134/26; 134/61

(57) ABSTRACT

After the completion of a cleaning process by deionized water on substrates in a first processing bath, alcohol is supplied to the first processing bath by an alcohol supply part, to replace a processing liquid in the first processing bath by alcohol. Then, a cleaning process by a liquid of fluorinated solvent is executed on the substrates in a second processing bath in a chamber. After that, the substrates are lifted out of the second processing bath, to be subjected to a drying process by gas of fluorinated solvent in the chamber. This prevents poor drying caused by complicated structures (trenches and holes) formed on the surfaces of the substrates.

### BACKGROUND OF THE INVENTION

1. Field of the Invention

The present invention relates to techniques for removing deionized water remaining on the surface of a substrate such as a semiconductor wafer and, more specifically, to a technique for preventing poor drying in such structures as trenches and holes formed on the surface of a substrate.

2. Description of the Background Art

In manufacturing steps of a semiconductor device, a variety of processing liquids are used by a coating process, an etching process and the like. This requires a substrate to be cleaned appropriately between each of the manufacturing steps.

In manufacturing steps of a semiconductor device, meanwhile, complicated structures such as trenches and holes may be formed on the surface of the substrate, leading to an uneven surface of the substrate.

Such complicated structures protrude or are dented from the substrate surface, causing deionized water having been used in cleaning the substrate surface to be more likely to remain, resulting in poor drying. For example, the deionized water is not removed sufficiently by a technique described in Japanese Patent Application Laid-Open No. 2002-252201.

### SUMMARY OF THE INVENTION

This invention is directed to techniques for removing deionized water remaining on the surface of a substrate such as a semiconductor wafer and, more specifically, to a technique for preventing poor drying in such structures as trenches and holes formed on the surface of a substrate.

To solve the above problem, in an aspect of the invention, a substrate processing apparatus for processing a substrate includes: a processing bath for storing a liquid of fluorinated solvent; a chamber for housing the processing bath; a holding mechanism moving between a first position in which substrates are arranged in the processing bath and a second position in which the substrates are arranged above the processing bath while holding the substrates in the chamber; and a gas supply part for, after the substrates having been processed by the liquid of fluorinated solvent in the first position are moved from the first position to the second position by the holding mechanism, supplying gas of fluorinated solvent to the substrates held by the holding mechanism.

The liquid of fluorinated solvent and the gas of fluorinated solvent are used to remove the processing liquid such as deionized water having been used for the cleaning from the substrate surfaces. Thus the processing liquid can be dried excellently with complicated structures such as trenches and holes formed on the surfaces of the substrates, thereby preventing poor drying (poor drying particularly caused by the processing liquid).

Preferably, the substrate processing apparatus, with the processing bath as a first processing bath and the holding mechanism as a first holding mechanism, further includes: a second processing bath for storing a processing liquid; a first supply mechanism for supplying deionized water as the processing liquid to the second processing bath; a second supply mechanism for supplying alcohol as the processing liquid to the second processing bath storing the deionized water as the processing liquid; a second holding mechanism moving between a position in which the substrates are arranged in the second processing bath and a position above the second processing bath while holding the substrates; and a transport mechanism for receiving the substrates from the second holding mechanism, transporting the substrates toward the chamber, and transferring the substrates to the first holding mechanism.

In the second processing bath, the substrates are processed by the deionized water and then processed by the alcohol. The substrates are therefore not exposed to an atmosphere including oxygen, with much of the deionized water remaining on the surfaces of the substrates, thereby preventing poor drying such as watermarks.

Still preferably, the substrate processing apparatus further includes: a first supply mechanism for supplying deionized water to the processing bath; a second supply mechanism for supplying alcohol to the processing bath; and a third supply mechanism for supplying the liquid of fluorinated solvent to be stored in the processing bath to the processing bath.

Because the procedure from the cleaning process to the drying process can be executed in a single processing bath, the substrates do not need to be transported until after the completion of the final drying process. This eliminates the need to transport the substrates with the deionized water remaining on the substrate surfaces, thereby preventing the deionized water from drying in an atmosphere including oxygen, which in turn prevents poor drying such as watermarks.

In another aspect of the invention, a substrate processing method for processing a substrate includes the steps of: (a) moving substrates having been transported into a chamber to a first position in a processing bath housed in the chamber; (b) processing the substrates having been moved to the first position by a liquid of fluorinated solvent stored in the processing bath; (c) moving the substrates having been processed by the liquid of fluorinated solvent from the first position to a second position above the processing bath; and (d) supplying gas of fluorinated solvent to the substrates having been moved to the second position.

It is therefore an object of this invention to prevent poor drying on the surfaces of substrates.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a substrate processing apparatus according to a first preferred embodiment of the present invention;

FIG. 2 illustrates a substrate processing apparatus according to a second preferred embodiment of the present invention; and

FIG. 3 is a flowchart of a procedure for processing substrates in a third processing section according to the second preferred embodiment.

### DESCRIPTION OF THE PREFERRED EMBODIMENTS

### 1. First Preferred Embodiment

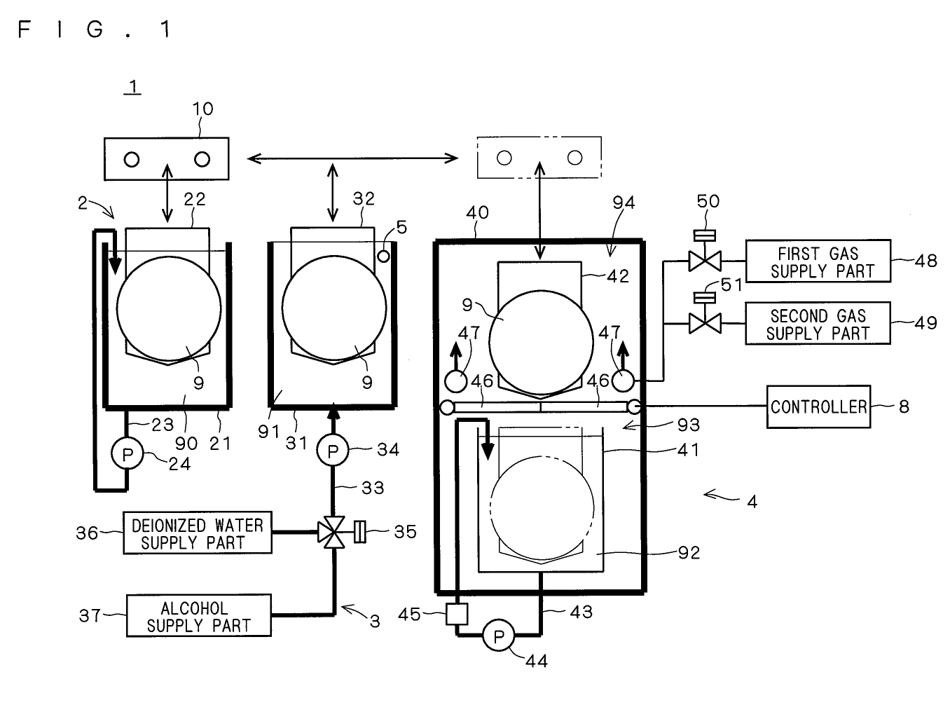

FIG. 1 illustrates a substrate processing apparatus 1 according to a first preferred embodiment of the present invention. The substrate processing apparatus 1 includes a transport robot 10, a first processing section 2, a second processing section 3, a third processing section 4, and a controller 8. Although not shown for brevity in FIG. 1, each element is connected to the controller 8 and operates based on a control signal from the controller 8 in the substrate processing apparatus 1.

The transport robot 10 transfers a plurality of substrates 9 to and from lifters 22, 32 and 42 which are described later. The transport robot 10 also transports the plurality of substrates 9 between the first processing section 2, the second processing section 3 and the third processing section 4 while holding the substrates 9, and acts as a transport mechanism in the present invention.

The first processing section 2 includes a processing bath 21 for storing a liquid chemical 90, a lifter 22 for moving up and down the substrates 9 while holding the substrates 9, a circulation pipe 23 serving as a flow path when circulating the liquid chemical 90 in the processing path 21, and a pump 24 for circulating the liquid chemical 90, and has the function of processing the substrates 9 by the liquid chemical 90. The first processing section 2 according to this embodiment uses a buffered hydrofluoric acid (BHF) liquid as the liquid chemical 90.

The lifter 22 lowers the substrates 9 received from the transport robot 10, to place the substrates 9 into the processing bath 21. By this operation, the substrates 9 held by the lifter 22 are immersed in the liquid chemical 90 stored in the processing bath 21.

The lifter 22 also raises the held substrates 9, to take out the substrates 9 in the processing bath 21. By this operation, the substrates 9 are lifted out of the liquid chemical 90, completing the process on the substrates 9 by the liquid chemical 90. The substrates 9 thus taken out of the processing bath 21 are transferred from the lifter 22 to the transport robot 10, to be transported toward the second processing section 3.

The second processing section 3 includes a processing bath 31 for storing a processing liquid 91, a lifter 32 for moving up and down the substrates 9 while holding the substrates 9, a supply pipe 33 serving as a flow path when supplying the processing liquid 91 to the processing bath 31 and having a downstream side connected in communication with the bottom of the processing bath 31, a pump 34 for sending the processing liquid 91 toward the processing bath 31, a three-way valve 35 for selectively opening and closing the supply pipe 33, a deionized water supply part 36 for supplying deionized water, and an alcohol supply part 37 for supplying alcohol, and has the function of cleaning the substrates 9 by the processing liquid 91.

The processing bath 31 stores deionized water or alcohol as the processing liquid 91. Namely, the processing bath 31 acts as a second processing bath in the present invention.

The lifter 32 lowers the substrates 9 received from the transport robot 10, to place the substrates 9 into the processing bath 31. The lifter 32 also raises the held substrates 9, to take out the substrates 9 in the processing bath 31.

The pump 34 is driven in response to a control signal from the controller 8. When the pump 34 is driven, deionized water or alcohol is sent depending on the state of the three-way valve 35 toward the processing bath 31 via the supply pipe 33.

The three-way valve 35 connects the deionized water supply part 36 or the alcohol supply part 37 in communication with the supply pipe 33 in response to a control signal from the controller 8. Namely, the controller 8 controls the three-way valve 35 to select a processing liquid 91 to be supplied from the supply pipe 33 to the processing bath 31.

The deionized water supply part 36 supplies “deionized water” as the processing liquid 91 to the processing bath 31 via the supply pipe 33. Namely, the deionized water supply part 36 and the supply pipe 33 act as a first supply mechanism in the present invention.

The alcohol supply part 37 supplies “alcohol” as the processing liquid 91 to the processing bath 31 via the supply pipe 33. Namely, the alcohol supply part 37 and the supply pipe 33 act as a second supply mechanism in the present invention.

Described next is a processing operation on the substrates 9 in the second processing section 3. When transported to the second processing section 3 by the transport robot 10, the substrates 9 are transferred from the transport robot 10 to the elevated lifter 32 above the processing bath 31, starting the process in the second processing section 3.

The lifter 32 having received the substrates 9 moves down while holding the substrates 9. By this operation, the substrates 9 held by the lifter 32 are placed into the processing bath 31, to be immersed in the processing liquid 91 stored in the processing bath 31.

In the substrate processing apparatus 1, deionized water is previously supplied from the deionized water supply part 36 toward the processing bath 31 via the supply pipe 33 before the substrates 9 are placed into to the processing bath 31 by the lifter 32. Namely, “deionized water” as the processing liquid 91 has been stored in the processing bath 31 by the time the substrates 9 are placed into the processing bath 31. Put another way, the process in the second processing section 3 starts with cleaning by deionized water.

When the process by deionized water has progressed sufficiently, the three-way valve 35 switches in response to a control signal from the controller 8, for the alcohol supply part 37 to start supplying alcohol to the processing bath 31 via the supply pipe 33.

As such, in the substrate processing apparatus 1 according to this embodiment, both the process by deionized water and the process by alcohol are carried out successively in the processing bath 31 without lifting the substrates 9 out of the deionized water for transport during those processes.

Furthermore, in the second processing section 3, alcohol is not supplied to the processing bath 31 after completely draining the deionized water in the processing bath 31 (liquid exchange), but is supplied from the alcohol supply part 37 to the processing bath 31 storing the deionized water (liquid replacement). In this process, the deionized water overflows to be drained from the top portion of the processing bath 31, gradually increasing alcohol concentration in the processing bath 31.

During the liquid replacement from deionized water to alcohol as mentioned above, the controller 8 controls the alcohol supply part 37 to supply alcohol to the processing bath 31, while monitoring the alcohol concentration in the processing liquid 91 by a concentration meter 5 provided in the processing bath 31. When the alcohol concentration of the processing liquid 91 reaches a predetermined value (e.g. 50% or more), the controller 8 controls the alcohol supply part 37 to stop supplying alcohol to the processing bath 31.

If the deionized water is drained from the processing bath 31 instead of the “liquid replacement” from deionized water to alcohol, the surface of the deionized water moves down with reduction in the amount of stored deionized water, causing the surfaces of the substrates 9 to be gradually exposed from the deionized water. Namely, if the deionized water is drained without supplying alcohol, the surfaces of the substrates 9 are exposed to an atmosphere including oxygen, with the deionized water remaining inside the trenches, holes and the like formed on the surfaces of the substrates 9. Evaporation of deionized water in an atmosphere including oxygen can particularly cause poor drying such as watermarks on the substrates 9.

However, the substrate processing apparatus 1 according to this embodiment moves to the dehydrating process by alcohol without exposing the substrates 9 from deionized water to an atmosphere including oxygen. This prevents the deionized water from drying in an atmosphere including oxygen, preventing poor drying. Although not illustrated in detail, after the completion of the liquid replacement, the controller 8 controls the processing liquid 91 including alcohol to circulate in the processing bath 31 until after the process by alcohol has progressed sufficiently.

When the process by alcohol has progressed sufficiently, the lifter 32 rises while holding the substrates 9 in response to a control signal from the controller 8. By this operation, the substrates 9 are lifted out of the processing liquid 91 (alcohol having concentration higher than predetermined concentration), completing the process by alcohol on the substrates 9. Whether the process by alcohol has progressed sufficiently is determined by the controller 8 after a lapse of previously determined sufficient processing time.

Isopropyl alcohol ((CH3)2CHOH), ethanol (C2HOH) and methanol (CH3OH) are suited, though not restrictive, for the alcohol used as the processing liquid for the liquid replacement from the deionized water in this embodiment. As the processing liquid, it is preferable to use a liquid having not only lower surface tension than deionized water, but closer affinity with deionized water (dehydrating effect), as well as high volatility which makes drying easy and leaves no solid objects.

The substrates 9 thus taken out of the processing bath 31 by the lifter 32 are transferred to the transport robot 10, to be transported toward the third processing section 4. The processing operation in the second processing section 3 is carried out as described above.

The third processing section 4 includes a chamber 40, a processing bath 41, a lifter 42, a circulation pipe 43 for circulating a processing liquid 92 in the processing bath 41, a pump 44 for sending the processing liquid 92 in the circulation pipe 43, and a heater 45 for heating the processing liquid 92 flowing through the circulation pipe 43. The circulation pipe 43 has an upstream side connected in communication with the bottom of the processing bath 41, and supplies the processing liquid 92 to the processing bath 41 from a downstream side.

With respect to the lifter 42, the position indicated by an alternate long and two short dashed line in FIG. 1 is called a “first position”, and the position indicated by a solid line is called a “second position”. In addition, the space inside the chamber 40 is vertically divided into first space 93 and second space 94, with the first space 93 housing the processing bath 41, and the second space 94 housing the lifter 42 which has moved to the second position.

The processing bath 41 stores a liquid of fluorinated solvent as the processing liquid 92. Namely, the processing bath 41 acts as a first processing bath in the present invention. The processing liquid 92 stored in the processing bath 41 is circulated by the circulation pipe 43 and the pump 44, and kept warm to a predetermined temperature by the heater 45 provided to the circulation pipe 43.

The third processing section 4 according to this embodiment uses hydrofluoroether (HFE) or hydrofluorocarbon (HFC) as the fluorinated solvent. The heater 45 keeps the circulating processing liquid 92 including HFE or HFC warm such that the working temperature of the processing liquid 92 falls within the range from 20° C. to the boiling point.

Like the lifters 22 and 32, the lifter 42 has the function of holding the plurality of substrates 9, and transfers the substrates 9 to and from the transport robot 10 above the chamber 40. The lifter 42 also moves between the first position in which the substrates 9 are arranged vertically in the processing bath 41 and the second position in which the substrates 9 are arranged outside the processing bath 41, while holding the substrates 9 in the chamber 40. Namely, the lifter 42 has the function of moving the substrates 9 between the first space 93 and the second space 94 in the chamber 40.

The third processing section 4 further includes an open/close mechanism 46, a discharge nozzle 47, a first gas supply part 48, a second gas supply part 49, and open/close valves 50 and 51.

The open/close mechanism 46 is provided as a pair between the first space 93 and the second space 94, and opens and closes the first space 93 with respect to the second space 94 in the chamber 40 in response to a control signal from the controller 8. Namely, the first space 93 and the second space 94 are connected in communication with each other when the open/close mechanism 46 is open, and are isolated from each other when the mechanism 46 is closed.

The discharge nozzle 47 is provided as a pair on both sides inside the second space 94, and discharges gas supplied from the first gas supply part 48 and the second gas supply part 49 (gas of fluorinated solvent or nitrogen gas) toward the second space 94 in the chamber 40.

The first gas supply part 48 supplies gas of fluorinated solvent toward the discharge nozzle 47. By this operation, the first gas supply part 48 supplies the gas of fluorinated solvent via the discharge nozzle 47 to the substrates 9 held by the lifter 42 which has moved to the second position.

The second gas supply part 49 supplies nitrogen gas to the discharge nozzle 47. By this operation, the second gas supply part 49 supplies the nitrogen gas via the discharge nozzle 47 to the substrates 9 held by the lifter 42 which has moved to the second position.

The open/close valve 50 opens and closes a gas pipe between the discharge nozzle 47 and the first gas supply part 48 in response to a control signal from the controller 8. When the open/close valve 50 is open, gas of fluorinated solvent is supplied from the first gas supply part 48 to the discharge nozzle 47, to be supplied into the second space 94 in the chamber 40. When the open/close valve 50 is closed, on the other hand, the first gas supply part 48 suspends the supply.

The open/close valve 51 opens and closes a gas pipe between the discharge nozzle 47 and the second gas supply part 49 in response to a control signal from the controller 8. When the open/close valve 51 is open, nitrogen gas is supplied from the second gas supply part 49 to the discharge nozzle 47, to be supplied into the second space 94 in the chamber 40. When the open/close valve 51 is closed, on the other hand, the second gas supply part 49 suspends the supply.

Although not illustrated in detail, the third processing section 4 further includes an exhaust mechanism for exhausting air from the first space 93 and the second space 94, respectively.

Described next is a processing operation on the substrates 9 in the third processing section 4. When transported to the third processing section 4 by the transport robot 10, the substrates 9 are transferred from the transport robot 10 to the elevated lifter 42, starting the process in the third processing section 4. At this time in the third processing section 4, the open/close mechanism 46 is open, and the processing liquid 92, a liquid of fluorinated solvent, has been stored in the processing bath 41.

The lifter 42 having received the substrates 9 moves down to the first position in the processing bath 41 while holding the substrates 9. By this operation, the substrates 9 held by the lifter 42 are placed into the processing bath 41, to be immersed in the processing liquid 92 stored in the processing bath 41. Namely, the process by the liquid of fluorinated solvent is started on the substrates 9.

The processing liquid 91 (alcohol) used in the second processing section 3 remains on the surfaces of the substrates 9 having been subjected to the second processing section 3. Particularly when the substrates 9 have trench structures and hole structures formed thereon, the alcohol tends to remain in clearance of these structures. Still, by immersing such substrates 9 in the processing liquid 92, a liquid of fluorinated solvent, the alcohol remaining on the substrates 9 can be removed effectively.

When the lifter 42 moves down to the first position, the controller 8 closes the open/close mechanism 46. By this operation, the first space 93 and the second space 94 are isolated during the process on the substrates 9 by the liquid of fluorinated solvent, preventing the atmosphere of the first space 93 from mixing into the second space 94. The atmosphere inside the first space 93 at this time is relatively contaminated due to the substrates 9 having been transported before being processed by the processing liquid 92. Thus, the isolation between the first space 93 and the second space 94 allows the inside of the second space 94 to be kept clean.

When the process by the processing liquid 92 has progressed sufficiently, the controller 8 opens the open/close mechanism 46. By this operation, the first space 93 and the second space 94 become connected in communication with each other again. During the cleaning process on the substrates 9 by the liquid of fluorinated solvent, the atmosphere of the first space 93 is exhausted to the outside by the aforementioned exhaust mechanism. Therefore, the atmosphere of the first space 93 is relatively purified at this point, reducing the adverse effect caused by the mixing of the atmosphere inside the first space 93 into the second space 94.

When the open/close mechanism 46 opens, the lifter 42 starts moving toward the second position while holding the substrates 9. By this operation, the substrates 9 are lifted out of the processing liquid 92, completing the process on the substrates 9 by the processing liquid 92.

When the lifter 42 moves to the second position, the open/close mechanism 46 closes, isolating the first space 93 and the second space 94 again.

Next, the open/close valve 50 opens, causing gas of fluorinated solvent to be discharged from the first gas supply part 48 into the second space 94 via the discharge nozzle 47. Namely, the gas of fluorinated solvent is supplied to the substrates 9 held by the lifter 42 which has moved to the second position. By this operation, a drying process by the gas of fluorinated solvent is started on the substrates 9.

When the process by the gas of fluorinated solvent has progressed sufficiently, the open/close valve 50 closes to suspend the supply of the gas of fluorinated solvent, while the open/close valve 51 opens, causing nitrogen gas to be discharged from the second gas supply part 49 into the second space 94 via the discharge nozzle 47. By this operation, the gas of fluorinated solvent is replaced with the nitrogen gas as the atmosphere inside the second space 94, starting a drying process by the nitrogen gas.

Because the first space 93 and the second space 94 are isolated at this time, gas of fluorinated solvent generated inside the first space 93 due to the evaporation of the processing liquid 92 remains inside the first space 93 without mixing into the second space 94.

Moreover, the isolation between the first space 93 and the second space 94 by the open/close mechanism 46 reduces the volume of processing space for the substrates 9 held by the lifter 42 which has moved to the second position. This curbs the amount of nitrogen gas consumed by the drying process.

When the process by the nitrogen gas has progressed sufficiently, the open/close valve 51 closes, and the lifter 42 rises to transfer the substrates 9 held by the lifter 42 to the transport robot 10. The transport robot 10 delivers the received substrates 9 from the substrate processing apparatus 1. The processing operation in the third processing section 4 is carried out as described above.

The controller 8 includes a CPU and a storage device which are not shown, and controls the elements of the substrate processing apparatus 1 with the CPU operating in accordance with a program stored in the storage device.

For example, the controller 8 controls the alcohol supply part 37 to supply alcohol toward the processing bath 31 storing deionized water as the processing liquid 91.

The controller 8 also controls the open/close mechanism 46 to isolate the first space 93 and the second space 94 when the lifter 42 holding the substrates 9 has moved to the first position or to the second position. On the other hand, the controller 8 controls the open/close mechanism 46 to bring the first space 93 and the second space 94 in communication with each other while the lifter 42 holding the substrates 9 moves between the first position and the second position. Namely, the controller 8 acts as an open/close controller in the present invention.

The controller 8 further includes an operating section (a keyboard and a variety of buttons) and a display section (liquid crystal display) which are not shown. An operator is thus capable of providing instructions appropriately to the substrate processing apparatus 1 by operating the operating section, and checking the condition and the like of the substrate processing apparatus 1 by checking the display on the display section.

As has been described, the substrate processing apparatus 1 according to the first preferred embodiment uses the liquid of fluorinated solvent and then also uses the gas of fluorinated solvent to dry the substrates in the third processing section 4, thereby drying the substrates excellently with complicated structures formed on the surfaces of the substrates.

### 2. Second Preferred Embodiment

In the first preferred embodiment, the bath for the process by deionized water and alcohol (processing bath 31) and the bath for the process by a liquid of fluorinated solvent (processing bath 41) are provided separately. Alternatively, those processes may be performed in the same bath.

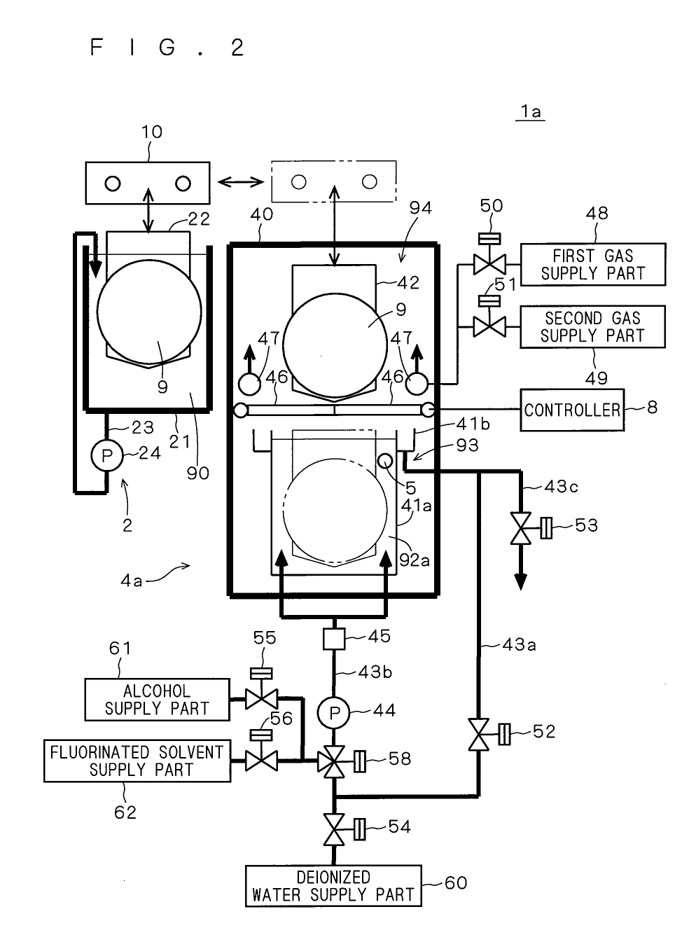

FIG. 2 illustrates a substrate processing apparatus la according to a second preferred embodiment of the present invention. In the substrate processing apparatus 1 a according to the second preferred embodiment, the elements that are similar to those of the substrate processing apparatus 1 according to the first preferred embodiment have the same reference numerals and a discussion of these elements is not replicated below.

The substrate processing apparatus 1a according to this embodiment does not include a structure corresponding to the second processing section 3 in the substrate processing apparatus 1, and includes a third processing section 4a instead of the third processing section 4. Thus the substrates 9 having been processed by the first processing section 2 are transported toward the third processing section 4a by the transport robot 10.

The third processing section 4a includes a processing bath 41a and an auxiliary bath 41b. The processing bath 41a almost corresponds to the processing bath 41 in the third processing section 4, and the substrates 9 are placed therein by the lifter 42. The auxiliary bath 41b is disposed at the top portion of the processing bath 41a to surround the circumference of the processing bath 41a, and has the function of collecting a processing liquid 92a having overflowed from the top portion of the processing bath 41a.

The third processing section 4a includes a circulation pipe 43a, a supply pipe 43b and a drainage pipe 43c as pipes to form a liquid flow path. The third processing section 4a further includes open/close valves 52 to 56 disposed in predetermined positions, respectively, for opening and closing the pipes in response to control by the controller 8, and a three-way valve 58 for selectively bringing two pipings in communication with the supply pipe 43b in response to control by the controller 8.

In the FIG. 2 example, pipes from the circulation pipe 43a and pipes from a deionized water supply part 60 are the first piping in the three-way valve 58, and pipes from an alcohol supply part 61 and a fluorinated solvent supply part 62 are the second piping. Yet this classification is not restrictive.

The circulation pipe 43a is used to circulate the processing liquid 92a, and is opened and closed mainly by the open/close valve 52. When the open/close valve 52 is open and also the three-way valve 58 selects the first piping, the processing liquid 92a collected by the auxiliary bath 41b by having overflowed from the processing bath 41a is guided by the circulation pipe 43a having an upstream side connected in communication with the bottom of the auxiliary bath 41b, to return to the processing bath 41a again via the supply pipe 43b.

The supply pipe 43b serves as a flow path for a liquid to be supplied to the processing bath 41a. Namely, liquids passing through the supply pipe 43b are supplied to the processing bath 41a, to become the processing liquid 92a. The liquids supplied toward the supply pipe 43b include a liquid supplied from the aforementioned circulation pipe 43a (the circulating processing liquid 92a), deionized water supplied from the deionized water supply part 60, alcohol supplied from the alcohol supply part 61, and a liquid of fluorinated solvent supplied from the fluorinated solvent supply part 62. In this embodiment, HFE is again used as the liquid of fluorinated solvent as in the first preferred embodiment.

When supplying the liquid from the circulation pipe 43a or deionized water to the processing bath 41a, the supply pipe 43b is connected to the aforementioned first piping by the three-way valve 58. When supplying alcohol or HFE to the processing bath 41a, on the other hand, the supply pipe 43b is connected to the aforementioned second piping by the three-way valve 58.

The drainage pipe 43c is used to drain liquids to the outside of the substrate processing apparatus 1a, and is opened and closed mainly by the open/close valve 53. When the open/close valve 53 is open, the processing liquid 92a collected by the auxiliary bath 41b by having overflowed from the processing bath 41a is guided by the drainage pipe 43c, to be drained to the outside. To drain the processing liquid 92 efficiently, the drainage pipe 43c may be provided with a pump.

The third processing section 4a includes the deionized water supply part 60, the alcohol supply part 61 and the fluorinated solvent supply part 62 as a structure to supply a variety of liquids to the processing bath 41a. The deionized water supply part 60 supplies deionized water to the processing bath 41a when the open/close valve 54 is open. The alcohol supply part 61 supplies alcohol to the processing bath 41a when the open/close valve 55 is open. The fluorinated solvent supply part 62 supplies HFE, a liquid of fluorinated solvent, to the processing bath 41a when the open/close valve 56 is open.

The substrate processing apparatus 11a according to the second preferred embodiment has such configuration and functions as described above.

Described next is a method of processing the substrates 9 by the third processing section 4a of the substrate processing apparatus 1a.

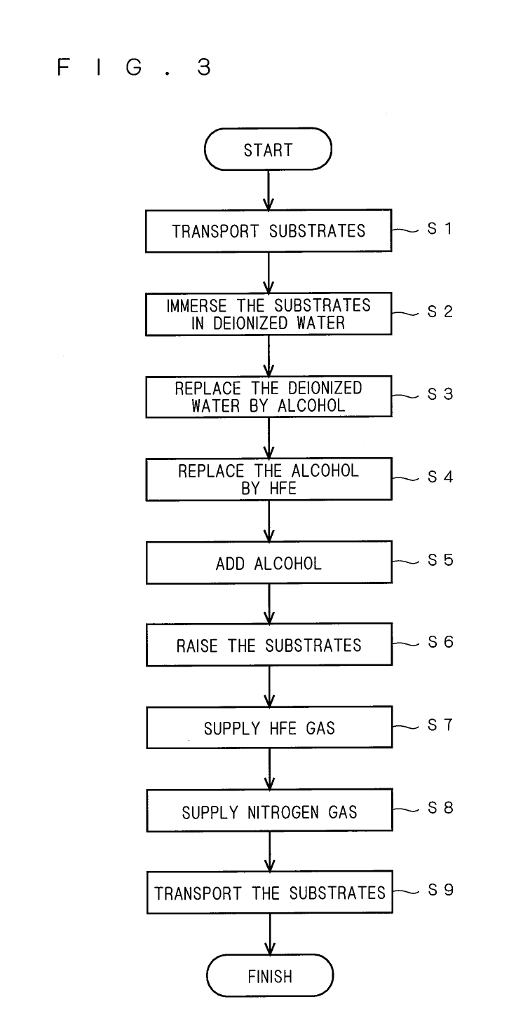

FIG. 3 is a flowchart of a procedure for processing the substrates 9 in the third processing section 4a according to the second preferred embodiment. Prior to starting the procedure shown in FIG. 3, a predetermined preparatory step is executed in the third processing section 4a for filling the processing bath 41a with the processing liquid 92a (deionized water).

In the preparatory step, the controller 8 controls the three-way valve 58 to select the first piping, and controls the open/close valve 52 to close and the open/close valve 54 to open. Then the pump 44 is driven, to start supplying deionized water from the deionized water supply part 60. When a predetermined amount of deionized water has been supplied from the deionized water supply part 60, the controller 8 controls the open/close valve 54 to close to suspend the deionized water supply from the deionized water supply part 60, while controlling the open/close valve 52 to open to start circulating the deionized water. At this time, the heater 45 may adjust temperature in order to keep the temperature of the circulating deionized water constant.

After the completion of such preparatory step, the transport robot 10 transports the substrates 9 to the third processing section 4a (step S1). When the substrates 9 are transported, the controller 8 controls the open/close mechanism 46 to open, and the lifter 42 receives the transported substrates 9 from the transport robot 10 and starts moving down.

The lifter 42 moves down to the first position, to immerse the substrates 9 in the processing liquid 92a (deionized water) stored in the processing bath 41a (step S2). By this operation, a cleaning process by deionized water is started on the substrates 9 in the third processing section 4a. When the liter 42 moves to the first space 93, the controller 8 controls the open/close mechanism 46 to close.

When the cleaning process by deionized water has progressed sufficiently after a lapse of predetermined time, the processing liquid 92a (deionized water) in the processing bath 41a is replaced by alcohol (step S3), to execute a dehydrating process by alcohol on the substrates 9.

In step S3, the controller 8 initially controls the three-way valve 58 to select the second piping, while controlling the open/close valve 52 to close to stop the circulation of the processing liquid 92a. The controller 8 also controls the open/close valve 53 to open to start draining the processing liquid 92a. Simultaneously with this operation, the controller 8 controls the open/close valve 55 to open to start supplying alcohol from the alcohol supply part 61.

With the alcohol supply from the alcohol supply part 61, the processing liquid 92a having relatively low alcohol concentration overflows from the top portion of the processing bath 41a, to be collected by the auxiliary bath 41b. The processing liquid 92a thus collected (the processing liquid 92a having relatively low alcohol concentration) passes through the drainage pipe 43c, to be drained to the outside. As such, the deionized water is gradually replaced by the alcohol as the processing liquid 92a in the processing bath 41a, as in the processing bath 31 according to the first preferred embodiment.

Further, upon detecting that the alcohol has reached predetermined concentration (e.g. 50% or more) based on the output from the concentration meter 5 as in the first preferred embodiment, the controller 8 determines that the replacement by alcohol has been completed. Then, the controller 8 controls the three-way valve 58 to select the first piping, while controlling the open/close valve 52 to open and the open/close valve 53, 55 to close. By this operation, the processing liquid 92a (alcohol) starts circulating, to move to a dehydrating process by alcohol on the substrates 9 as in the first preferred embodiment.

As described, in the substrate processing apparatus la according to the second preferred embodiment, the third processing section 4a executes the processes (steps S1 to S3) that are equivalent to those executed by the second processing section 3 in the substrate processing apparatus 1 according to the first preferred embodiment.

When the process by alcohol has progressed sufficiently, the processing liquid 92a (alcohol) in the processing bath 41a is replaced by HFE (step S4), to execute a process by HFE on the substrates 9.

In step S4, the controller 8 initially controls the three-way valve 58 to select the second piping, while controlling the open/close valve 52 to close to stop the circulation of the processing liquid 92a. The controller 8 also controls the open/close valve 53 to open to start draining the processing liquid 92a. Simultaneously with this operation, the controller 8 controls the open/close valve 56 to open to start supplying HFE from the fluorinated solvent supply part 62.

With the HFE supply from the fluorinated solvent supply part 62, the processing liquid 92a having relatively low HFE concentration overflows from the top portion of the processing bath 41a, to be collected by the auxiliary bath 41b. The processing liquid 92a thus collected (the processing liquid 92a having relatively low HFE concentration) passes through the drainage pipe 43c, to be drained to the outside. As such, the alcohol is gradually replaced by the HFE as the processing liquid 92a in the processing bath 41a.

Further, upon detecting that the alcohol has reached predetermined concentration (e.g. several percent or less) based on the output from the concentration meter 5, the controller 8 determines that the replacement by HFE has been completed. Then, the controller 8 controls the three-way valve 58 to select the first piping, while controlling the open/close valve 52 to open and the open/close valve 53, 56 to close. By this operation, the processing liquid 92a (HFE) in the processing bath 41a starts circulating, to move to a process by HFE on the substrates 9 as in the first preferred embodiment.

In the substrate processing apparatus 1 according to the first preferred embodiment, the substrates 9 are taken out of alcohol upon completion of the dehydrating process by alcohol, to be transported by the transport robot 10. In the substrate processing apparatus 1a according to the second preferred embodiment, on the other hand, alcohol is replaced by HFE in the above step (step S4) to execute the process by HFE without transporting the substrates 9.

Upon completion of the process by HFE on the substrates 9, the controller 8 adds alcohol (about 10%) into the processing bath 41a (step S5). By this operation, the deionized water remaining inside the complicated structures on the surfaces of the substrates 9 can be further removed.

In step S5, the controller 8 initially controls the three-way valve 58 to select the second piping, while controlling the open/close valve 52 to close to stop the circulation of the processing liquid 92a. The controller 8 also controls the open/close valve 53 to open to start draining the processing liquid 92a (HFE). Simultaneously with this operation, the controller 8 controls the open/close valve 55 to open to start supplying alcohol from the alcohol supply part 61.

With the alcohol supply from the alcohol supply part 61, the processing liquid 92a having relatively high HFE concentration overflows from the top portion of the processing bath 41a, to be collected by the auxiliary bath 41b. The processing liquid 92a thus collected (the processing liquid 92a having relatively high HFE concentration) passes through the drainage pipe 43c, to be drained to the outside.

Then, upon detecting that the alcohol has reached predetermined concentration (about 10%) based on the output from the concentration meter 5, the controller 8 controls the three-way valve 58 to select the first piping, while controlling the open/close valve 52 to open and the open/close valve 53, 55 to close. By this operation, the processing liquid 92a (HFE+alcohol) in the processing bath 41a starts circulating.

After a lapse of predetermined time, the controller 8 controls the open/close mechanism 46 to open. Then, the lifter 42 starts rising to the second position while holding the substrates 9, to lift the substrates 9 out of the processing bath 41a (step S6).

When the lifter 42 moves to the second position to move the substrates 9 to the second space 94, the open/close mechanism 46 closes, isolating the first space 93 and the second space 94 again.

Next, the open/close valve 50 opens, causing gas of fluorinated solvent to be discharged from the first gas supply part 48 into the second space 94 via the discharge nozzle 47. Namely, the gas of fluorinated solvent is supplied to the substrates 9 held by the lifter 42 which has moved to the second position. By this operation, a drying process by the gas of fluorinated solvent is started on the substrates 9 (step S7) as in the substrate processing apparatus 1 according to the first preferred embodiment.

When the process by the gas of fluorinated solvent has progressed sufficiently, the open/close valve 50 closes to suspend the supply of the gas of fluorinated solvent, while the open/close valve 51 opens, causing nitrogen gas to be discharged from the second gas supply part 49 into the second space 94 via the discharge nozzle 47. By this operation, a drying process by the nitrogen gas is started on the substrates 9 (step S8) as in the substrate processing apparatus 1 according to the first preferred embodiment.

When the process by nitrogen gas has progressed sufficiently, the open/close valve 51 closes, and the lifter 42 rises to transfer the substrates 9 held by the lifter 42 to the transport robot 10. The transport robot 10 then delivers the received substrates 9 from the substrate processing apparatus 1a (step S9).

As described, the substrate processing apparatus 1a according to the second preferred embodiment produces effects that are similar to those of the substrate processing apparatus 1 according to the first preferred embodiment.

Further, the substrate processing apparatus 1a, which includes the deionized water supply part 60 for supplying deionized water to the processing bath 41a, the alcohol supply part 61 for supplying alcohol to the processing bath 41a and the fluorinated solvent supply part 62 for supplying HFE to be stored in the processing bath 41a to the processing bath 41a, executes the procedure from the cleaning process by deionized water to the process by HFE in the single processing bath 41a. Thus, the size of the apparatus can be reduced.

Because the procedure from the cleaning process to the drying process can be executed in a single processing bath, the substrates 9 do not need to be transported until after the completion of the final drying process. This eliminates the need to transport the substrates 9 with the deionized water remaining on the substrate surfaces, thereby preventing the deionized water from drying in an atmosphere including oxygen, which in turn prevents poor drying such as watermarks.

Moreover, the fluorinated solvent supply part 62 supplies HFE to the processing bath 41a storing alcohol. With such replacement of alcohol by HFE without exchanging them, the substrates 9 are not taken out of the alcohol. Typically, the atmosphere inside the first space 93 (the second space 94) is adjusted to have low oxygen concentration, but is not necessarily under completely anoxic conditions. In the substrate processing apparatus 1a according to this embodiment, the substrates 9 are not exposed to the atmosphere inside the first space 93 (the second space 94) until after the completion of all drying processes (until after removing as much deionized water as possible). This prevents the deionized water from drying in an atmosphere including oxygen, which in turn prevents poor drying such as watermarks.

### 3. Modifications

The present invention can be modified in various manners.

For example, while the first gas supply part 48 and the second gas supply part 49 were described as sharing the discharge nozzle 47 in the above embodiments, these parts may of course include separate discharge nozzles.

Also, the open/close mechanism 46 may be replaced by a mechanism driving a cover that isolates the first space 93 and the second space 94.

In the first preferred embodiment, the process by a liquid of fluorinated solvent is executed for the predetermined time in the third processing section 4, and the substrates 9 are lifted directly after that. Alternatively, alcohol (e.g. about 10%) may be added to the processing liquid 92 before lifting the substrates 9, as in the second preferred embodiment.

In the above embodiments, the process is changed while measuring the alcohol concentration by the concentration meter 5. An alternative would be to previously measure the time until the predetermined alcohol concentration is reached, and to change the process by the controller 8 based on the previously measured time (set time).

In the second preferred embodiment, the process by the liquid chemical 90 is executed in the processing bath 21 of the first processing section 2. Alternatively, the process by the liquid chemical 90 may be executed in the third processing section 4a by providing a supply part for supplying the liquid chemical 90 to the processing bath 41a. In that case, the procedure from the liquid chemical process to the drying process can be executed in the single processing bath 41a.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus for processing a substrate, comprising:
a processing bath for storing a liquid of fluorinated solvent;
a chamber for housing said processing bath;
a holding mechanism moving between a first position in which substrates are arranged in said processing bath and a second position in which said substrates are arranged above said processing bath while holding said substrates in said chamber; and
a gas supply part for, after said substrates having been processed by said liquid of fluorinated solvent in said first position are moved from said first position to said second position by said holding mechanism, supplying gas of fluorinated solvent to said substrates held by said holding mechanism.

2. The substrate processing apparatus according to claim 1, further comprising:
an open/close mechanism for opening and closing first space housing said processing bath with respect to second space housing said holding mechanism having moved to said second position in said chamber; and
an open/close controller for controlling said open/close mechanism to isolate said first space and said second space when said holding mechanism holding said substrates has moved to said first position and when said holding mechanism holding said substrates has moved to said second position, and controlling said open/close mechanism to bring said first space and said second space in communication with each other when said holding mechanism holding said substrates moves between said first position and said second position.

3. The substrate processing apparatus according to claim 1, with said processing bath as a first processing bath and said holding mechanism as a first holding mechanism, further comprising:
a second processing bath for storing a processing liquid;
a first supply mechanism for supplying deionized water as said processing liquid to said second processing bath;
a second supply mechanism for supplying alcohol as said processing liquid to said second processing bath storing said deionized water as said processing liquid;
a second holding mechanism moving between a position in which said substrates are arranged in said second processing bath and a position above said second processing bath while holding said substrates; and
a transport mechanism for receiving said substrates from said second holding mechanism, transporting said substrates toward said chamber, and transferring said substrates to said first holding mechanism.

4. The substrate processing apparatus according to claim 1, further comprising:
a first supply mechanism for supplying deionized water to said processing bath;
a second supply mechanism for supplying alcohol to said processing bath; and
a third supply mechanism for supplying said liquid of fluorinated solvent to be stored in said processing bath to said processing bath.

5. The substrate processing apparatus according to claim 4, wherein said second supply mechanism supplies said alcohol to said processing bath storing said deionized water.

6. The substrate processing apparatus according to claim 4, wherein said third supply mechanism supplies said liquid of fluorinated solvent to said processing bath storing said alcohol.

7. The substrate processing apparatus according to claim 5, wherein said third supply mechanism supplies said liquid of fluorinated solvent to said processing bath storing said alcohol.

8. The substrate processing apparatus according to claim 3, wherein said alcohol includes one of isopropyl alcohol, ethanol and methanol.

9. The substrate processing apparatus according to claim 4, wherein said alcohol includes one of isopropyl alcohol, ethanol and methanol.

10. The substrate processing apparatus according to claim 1, wherein said fluorinated solvent includes one of hydrofluoroether and hydrofluorocarbon.

11. A substrate processing method for processing a substrate, comprising the steps of:
(a) moving substrates having been transported into a chamber to a first position in a processing bath housed in said chamber;
(b) processing said substrates having been moved to said first position by a liquid of fluorinated solvent stored in said processing bath;
(c) moving said substrates having been processed by said liquid of fluorinated solvent from said first position to a second position above said processing bath; and
(d) supplying gas of fluorinated solvent to said substrates having been moved to said second position.

12. The substrate processing method according to claim 11, wherein said fluorinated solvent includes one of hydrofluoroether and hydrofluorocarbon.

13. The substrate processing method according to claim 11, further comprising the steps of:
(e) supplying deionized water as a processing liquid to a different processing bath from said processing bath;
(f) processing said substrates by said deionized water stored in said different processing bath;
(g) supplying alcohol as said processing liquid to said different processing bath storing said deionized water as said processing liquid;
(h) processing said substrates by said alcohol stored in said different processing bath; and
(i) transporting said substrates having been processed by said alcohol in said step (h) toward said chamber, wherein
said step (a) is a step of moving said substrates having been transported into said chamber in said step (i) to said first position.

14. The substrate processing method according to claim 13, wherein said alcohol includes one of isopropyl alcohol, ethanol and methanol.

15. The substrate processing method according to claim 11, further comprising the step of:
(j) supplying, at least prior to executing said step (b), a liquid of fluorinated solvent to said processing bath storing alcohol, wherein
said step (b) is a step of processing said substrates by said liquid of fluorinated solvent supplied to said processing bath in said step (j).

16. The substrate processing method according to claim 15, wherein said alcohol includes one of isopropyl alcohol, ethanol and methanol.
